(19) United States
(12) Patent Application Publication
(10) Pub. No.: US 2007/0211970 A1
(43) Pub. Date: Sep. 13, 2007

(54) Multi-lobe foil gas bearing

(75) Inventors: Mari Nagata, Inuyama (JP); Minoru Hanahashi, Inuyama (JP); Kazuhiko Kawaike, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: Daido Metal Co., Ltd., Nagoya (JP)

(21) Appl. No.: 11/716,689

(22) Filed: Mar. 12, 2007

(30) Foreign Application Priority Data
Mar. 10, 2006 (JP) 2006-0066778

(51) Int. Cl. F16C 32/06

(52) U.S. Cl. 384/104

(57) ABSTRACT

A multi-lobe foil gas bearing which can accomplish high accuracy rotation by means of a stable fluid lubricating film without being affected by a rotational position or a driving system of a journal at the time of starting is provided. Since two foils are arranged with different phases in a circumferential direction so that each vertex part of one of the two foils is positioned in an arc surface part of the other foil in a plan view seen from a shaft end of the journal, a part having low rigidity and a part having high rigidity of the multi-lobe foil gas bearing compensate each other to eliminate a local part having low bearing rigidity. As a result, it is possible to eliminate a phenomenon such as moving or leaning of the journal at the time of starting, while the fluid lubricating film can exist over the entire circumferential surface of the journal to keep stable high accuracy rotation of the journal.

### BACKGROUND OF THE INVENTION

1. Field of the Invention

The present invention relates to a multi-lobe foil gas bearing including: a bearing retaining member surrounding a periphery of a journal via a clearance; a multi-lobe closed-loop shaped foil which is placed in the clearance to constitute a bearing sliding surface opposite to the journal and includes one or more vertex parts and arc surface parts the number of which corresponds to the number of vertex parts; and a viscoelastic material, an elastic material or a compound material of the viscoelastic material and the elastic material, which is filled into the clearance between the foil and the bearing retaining member opposite to the foil, wherein the multi-lobe foil gas bearing supports the journal by a fluid lubricating film formed by relative rotation between the journal and the bearing sliding surface.

2. Description of Related Art

There is disclosed a multi-lobe foil gas bearing relating to the above described structure in JP-A-2005-299922, which has been previously proposed by the present applicant.

The structure of the multi-lobe foil gas bearing disclosed in JP-A-2005-299922 mentioned above is that as shown in FIG. 5. In FIG. 5, a multi-lobe foil gas bearing 1 includes: a bearing retaining member 3 surrounding a periphery of a journal 2 via a clearance; a multi-lobe closed-loop shaped foil 4 which is placed within the clearance to constitute a bearing sliding surface opposite to the journal 2, and has one or more vertex parts 4a and bulge shaped arc surface parts 4b the number of which corresponds to the number of the vertex parts 4a; and a viscoelastic material 6 (or an elastic material or a compound material of the viscoelastic material and the elastic material) which is filled into the clearance between the foil 4 and the bearing retaining member 3, wherein the multi-lobe foil gas bearing supports the journal 2 by a fluid lubricating film formed by relative rotation between the journal 2 and the bearing sliding surface. The arc surface parts 4b described above mean arc parts of the foil 4 which correspond to the diameter D of the journal 2 when the journal 2 is placed coaxially with the foil 4. In addition, a clearance C1 is formed between the vertex parts 4a and an inner circumference of the bearing retaining member 3.

Objects of the multi-lobe foil gas bearing 1 having the above described structure are that it is easy to form a wedge-shaped fluid lubricating film, the bearing load capability is large, and it is easy to discharge wear particles, which are created by contact of the journal 2 and the bearing sliding surface at the time of starting and stopping, from the bearing sliding surface. Further, objects are that the bearing clearance can be easily set at the time of producing, it is easy to produce and assemble the gas bearing, and the gas bearing is suitable also in the case of supporting the journal 2 having a small diameter.

### BRIEF SUMMARY OF THE INVENTION

Accordingly, the multi-lobe foil gas bearing 1 having the structure shown in FIG. 5 is used as a journal bearing of a magnetic disk drive motor, a polygon mirror scanner motor, a color wheel motor of a rear projection television, for example. However, the journal moves toward the vertex part 4a having low rigidity of the multi-lobe foil gas bearing 1 at the time of starting, or leans toward the vertex part 4a, so that the journal 2 is forcefully in contact with an inflection point 4c of the vertex part 4a and the bulge shaped arc surface part 4b to cause increase in friction force at the time of starting, and increase in wear amount at the inflection point 4c.

In addition, because the fluid lubricating film formed by relative rotation of the journal 2 and the bearing sliding surface is a gas having low viscosity, the fluid lubricating film may be broken between the vertex part 4a and the inflection point 4c and therefore stable high rotation accuracy of the journal 2 may not be obtained.

The present invention is made in view of the above circumstances, and an object thereof is to provide a multi-lobe foil gas bearing which is not affected by rotational position or a driving method of the journal at the time of starting, and can support the journal by the fluid lubricating film which is stably present over the entire circumference of the journal 2.

A means employed by the invention according to claim 1 will be described with reference to the drawings. As shown in FIGS. 1A-1C, a multi-lobe foil gas bearing 1 comprises: a bearing retaining member 3 surrounding a periphery of a journal 2 via a clearance; a foil 41, 42 having a multi-lobe closed-loop shape, which foil is placed within the clearance to constitute a bearing sliding surface opposite to the journal 2, and include one or a plurality of vertex parts 41a, 42a and arc surface parts 41b, 42b of which the number corresponds to the number of vertex parts 41a, 42a; and a viscoelastic material 61, 62 (or an elastic material, or a compound material of the viscoelastic material and the elastic material may be used instead of the viscoelastic material) which is filled into the clearance between the foil 41, 42 and the bearing retaining member 3 opposite to the foil, wherein the multi-lobe foil gas bearing 1 supports the journal 2 by a fluid lubricating film formed by relative rotation of the journal 2 and the bearing sliding surface, a plurality of the foils 41, 42 (two foils in the figure) having the closed-loop shape are provided along an axial direction of the journal 2, and the plurality of foils 41, 42 are arranged with different phases in a circumferential direction so that each vertex part 41a of at least one foil 41 of the plurality of foils 41, 42 is positioned in the arc surface part 42b of the other foil 42 in a plan view seen from a shaft end of the journal 2 (an arrow C in the figure).

Further, a means employed by the invention according to claim 2 will be described with reference to the drawings. As shown in FIGS. 1A-1C, the multi-lobe foil gas bearing 1 according to claim 1 is characterized in that a plurality of the foils 41, 42 are arranged so as to be adjacent to each other, or placed with a predetermined distance d therebetween, in the axial direction of the journal 2.

Furthermore, a means employed by the invention according to claim 3 will be described with reference to the drawings. As shown in FIGS. 3A-3C, the multi-lobe foil gas bearing 1 according to claim 1 or claim 2 is characterized in that the number of the vertices (three vertices in this figure) of at least one foil 45 of the plurality of foils 45, 46, is different from the number (two vertices in this figure) of the vertices of the other foil 46.

In the invention according to claim 1, since the plurality of foils 41, 42 are arranged with different phases in a circumferential direction so that each vertex part 41a of at least one foil 41 of the plurality of foils 41, 42 is positioned in the arc surface part 42b of the other foil 42 in a plan view seen from a shaft end of the journal 2, a part having low rigidity and a part having high rigidity of the multi-lobe foil gas bearing 1 compensate each other to eliminate a local low bearing rigidity part. As a result, a phenomenon such as moving or leaning of the journal 2 at the time of starting can be reduced. In addition, even if a fluid lubricating film formed in the clearance 51 between one foil 41 and the journal 2 is broken near the vertex part 41a of the foil 41, a fluid lubricating film formed in the clearance 52 between the other foil 42 and the journal 2 exists, so that the fluid lubricating film is generated over the entire circumference of the journal 2 to support the journal 2, and therefore stable high accuracy rotation of the journal 2 can be kept.

Further, in the invention according to claim 2, even if the plurality of foils 41, 42 are placed adjacent to each other or placed with a predetermined distance d therebetween in the axial direction of the journal 2, high accuracy rotation of the journal 2 can be kept.

Furthermore, in the invention according to claim 3, with respect to the plurality of foils 45, 46, the number of the vertices of at least one foil 45 is different from the number of the vertices of the other foil 46. As a result, bearing rigidity and elasticity of the multi-lobe foil gas bearing vary in the axial direction of the journal 2 while the rigidity and elasticity of the fluid lubricating film formed during rotation also vary in the axial direction of the journal 2 to support the journal 2, and thus it becomes possible to generate an optimal fluid lubricating film for the rotation characteristic of the journal 2 to provide stable high accuracy rotation.

### BRIEF DESCRIPTION OF THE SEVERAL VIEWS OF THE DRAWINGS

FIG. 1A is a cross sectional view of a multi-lobe foil gas bearing according to a first embodiment of the invention;

FIG. 1B is an A-A line cross sectional view of the multi-lobe foil gas bearing shown in FIG. 1A;

FIG. 1C is a B-B line cross sectional view of the multi-lobe foil gas bearing shown in FIG. 1A;

FIG. 2A is a cross sectional view of a multi-lobe foil gas bearing according to a variant example of the first embodiment;

FIG. 2B is an A-A line cross sectional view of the multi-lobe foil gas bearing shown in FIG. 2A;

FIG. 2C is a B-B line cross sectional view of the multi-lobe foil gas bearing shown in FIG. 2A;

FIG. 3A is a cross sectional view of a multi-lobe foil gas bearing according to a second embodiment of the invention;

FIG. 3B is an A-A line cross sectional view of the multi-lobe foil gas bearing shown in FIG. 3A;

FIG. 3C is a B-B line cross sectional view of the multi-lobe foil gas bearing shown in FIG. 3A;

FIG. 4A is a cross sectional view of a motor for a hard disk drive to which a multi-lobe foil gas bearing according to an embodiment of the invention is applied;

FIG. 4B is a cross sectional view of a motor for a hard disk drive to which a multi-lobe foil gas bearing according to an embodiment of the invention is applied; and

FIG. 5 is a cross sectional view according to a conventional example of a multi-lobe foil gas bearing.

### DETAILED DESCRIPTION OF THE INVENTION

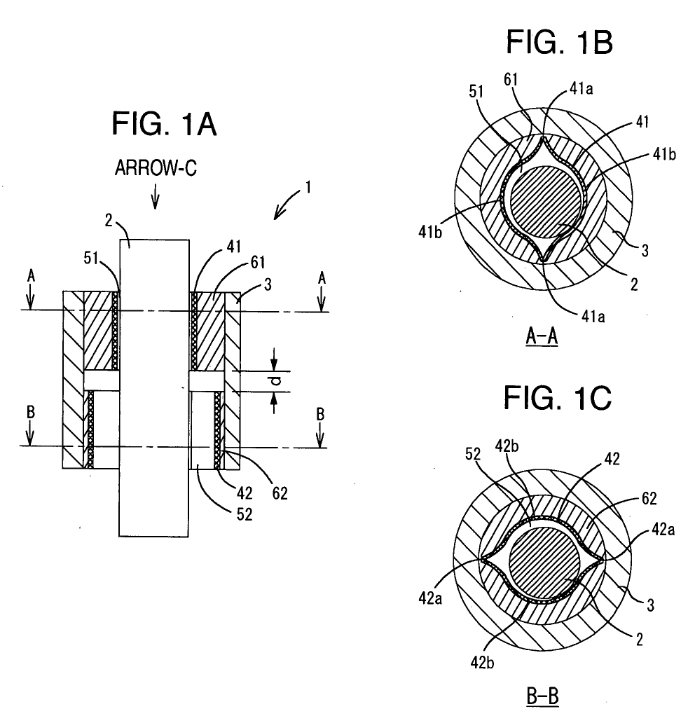

Hereinafter, embodiments of the present invention will be described with reference to the drawings. First, a first embodiment of the present invention will be described with reference to FIGS. 1A-1C. FIG. 1A is a cross sectional view of a multi-lobe foil gas bearing according to a first embodiment of the invention, FIG. 1B is an A-A line cross sectional view of the multi-lobe foil gas bearing shown in FIG. 1A, and FIG. 1C is a B-B line cross sectional view of the multi-lobe foil gas bearing shown in FIG. 1A.

The multi-lobe foil gas bearing 1 of the first embodiment includes two upper and lower foils 41, 42 in a bearing retaining member 3. The upper foil 41 and the lower foil 42 have multi-lobe closed-loop shapes, and include two vertex parts 41a, 42a and bulge shaped arc surface parts 41b, 42b, respectively. In addition, in clearances between peripheries of the foils 41, 42 and the bearing retaining member 3, an upper viscoelastic material 61 and a lower viscoelastic material 62 are filled so as to correspond to the foils 41, 42, respectively. The arc surface parts 41b, 42b in this embodiment (and also in other embodiments) are arc parts of the foils 41, 42 which correspond to the diameter of a journal 2, as with the conventional example shown in FIG. 5.

The foils 41, 42 are joined by superposing two planar rectangular thin plates on one another and then joining both end sides of the thin plates by means of welding such as spot welding, seam welding and laser welding, or adhesives, brazing or the like, so that the multi-lobe closed-loop shape having the vertex parts 41a, 42a (the joined parts constitute the vertex parts) and the bulge shaped arc surface parts 41b, 42b of the foils 41, 42 is formed when attaching the foils 41, 42 to a shaft. Further, when the foils 41, 42 are attached in the bearing retaining member 3, the foils 41, 42 are placed with a distance d therebetween (the distance d may be 0 to place them adjacent to each other) in an axial direction of the journal 2, with the vertex parts 41a of the upper foil 41 and the vertex parts 42a of the lower foil 42 having phases different from each other by 90° in a circumferential direction, in a plan view seen from an end of the journal 2 (an arrow C in the figure). For the foils 41, 42, metal thin plates made of stainless steel, phosphor bronze, brass, copper, aluminum or the like are used, and those thicknesses are 10 to 100 μm. Further, for the viscoelastic materials 61, 62, a rubber material made of silicone, acrylic or the like, or a macromolecular gel is used. Furthermore, in place of the viscoelastic materials 61, 62, an elastic material (a spring or a wave shaped foil, for example) may be used, or a compound material which is a mixture of the viscoelastic material and the elastic material may be used.

When the journal 2 is supported, predetermined bearing clearances 51, 52 are provided between the journal 2 and each of the foils 41, 42, and the clearances 51, 52 are distributed so that the bearing clearances 51, 52 are largest near the vertex parts 41a, 42a and smallest in an almost middle portion of two vertices. During stopping, the journal 2 is in contact with the upper and lower foils 41, 42 in the smallest portion of the bearing clearances 51, 52. In addition, the bearing clearances 51, 52 are generally designed so as to be equal to or smaller than about 3/1000 of the diameter of the journal 2 in the smallest portion of the bearing clearances 51, 52. In order to reduce rotation vibration of the journal 2, the bearing clearances 51, 52 may be set to be small. In the multi-lobe foil gas bearing in this embodiment (and also in other embodiments), even if the bearing clearances 51, 52 are little of nothing during stopping, a fluid lubricating film is formed at a certain number of revolutions or more due to the elastic effect of the foils 41, 42 and the viscoelastic materials 61, 62 supporting the foils, so that the journal 2 can be floated. In FIGS. 1 to 5, the thicknesses of the foils 41, 42 and the bearing clearances 51, 52 are shown in an exaggerated manner, for the sake of clarity.

Next, action of the multi-lobe foil gas bearing 1 configured in the above described manner will be described. The foils 41, 42 are placed to have the distance d therebetween in the axial direction of the journal 2 with the phase difference of the vertex parts 41a, 42a having low rigidity in the multi-lobe foil bearing, and therefore a part having low rigidity and a part having high rigidity of the multi-lobe foil gas bearing 1 compensate each other to eliminate a local low bearing rigidity part, which reduces a phenomenon such as moving or leaning of the journal 2 at the time of starting and thus the journal 2 can be stably started.

In addition, when the journal 2 rotates, fluid is drawn from the vicinity of the bearing clearances 51, 52 near the vertex parts 41a, 42a so that the fluid lubricating film is generated toward the middle portion where the clearance shape becomes narrower. In this case, since the foils 41, 42 are placed to have the distance d therebetween in the axial direction of the journal 2 with the phase difference between the vertex parts 41a, 42a of the foils 41, 42, even if the fluid lubricating film formed in the bearing clearance 51 between the upper foil 41 and the journal 2 is broken near the vertex part 41a of the foil 41, a fluid lubricating film formed in the clearance 52 between the lower foil 42 and the journal 2 is present, and thus the fluid lubricating film is generated over the entire circumference of the journal 2. By the restoring force and the damping force of this fluid lubricating film and the viscoelastic materials 61, 62, it becomes possible to support and damp imbalance vibration accompanying the rotation or the like to achieve stable high accuracy rotation.

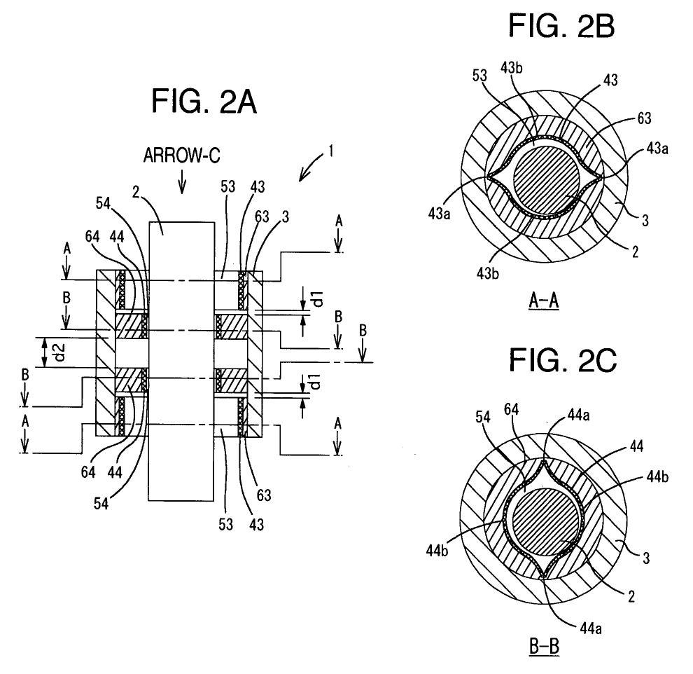

In the first embodiment described above, although the journal 2 is supported by two upper and lower foils 41, 42 each having two vertex parts and two arc surface parts, the journal 2 may be supported by two or more foils. Such a variant example of the first embodiment will be described with reference to FIGS. 2A-2C. FIG. 2A is a cross sectional view of a multi-lobe foil gas bearing according to the variant example of the first embodiment, FIG. 2B is an A-A line cross sectional view of the multi-lobe foil gas bearing shown in FIG. 2A, and FIG. 2C is a B-B line cross sectional view of the multi-lobe foil gas bearing shown in FIG. 2A.

The multi-lobe foil gas bearing 1 according to the variant example of the first embodiment includes: two outer foils 43 which are respectively provided in upper and lower end portions of the bearing retaining member 3 and include a multi-lobe closed-loop shape having two vertex parts 43a and two arc surface parts 43b; two inner foils 44 which are provided to have a distance d1 inwardly from the two outer foils 43 in the bearing retaining member 3 and have a multi-lobe closed-loop shape having two vertex parts 44a and two arc surface parts 44b; and outer viscoelastic materials 63 and inner viscoelastic materials 64 which are filled in clearances between the foils 43, 44 and the corresponding bearing retaining member 3. In other words, in this variant example, the journal 2 is supported by four foils in total, i.e. by two outer foils 43 and two inner foils 44, and the two inner foils 44 is set to have a distance d2 therebetween.

In this case, the vertex parts 43a of the outer foils 43 and the vertex parts 44a of the inner foils 44 are positioned so as to have the above described distances d1 and d2 (d1, d2≧0) therebetween in the axial direction of the journal 2, while shifting the phases by 90° from each other in a plan view (an arrow C in the figure). The foil width of the outer foils 43 and the foil width of the inner foils 44 do not necessary match with each other. The foil width of the outer foils 43 may be formed to be larger than the foil width of the inner foils 44 as shown in the figure, or the foil widths are not necessarily the same between the outer foils 43 or between the inner foils 44. Further, depending on rotation characteristics of the journal 2, the material and the thickness of the foils 43, 44 or the material and the hardness of the viscoelastic materials 63, 64 may be differently selected and used between the foils and between the viscoelastic materials, in order to obtain stable starting and high accuracy rotation. Also in the variant example of the first embodiment configured in the above described manner, as in the first embodiment, a part having low rigidity and a part having high rigidity in the multi-lobe foil gas bearing 1 compensate each other to eliminate a local low bearing rigidity part. As a result, the phenomenon such as movement or leaning of the journal 2 at the time of starting are reduced so that the journal 2 can be stably started. At the same time, by the restoring force and the damping force of the fluid lubricating films formed on the outer and inner foils 43, 44 and the viscoelastic materials 63, 64, imbalance vibration accompanying rotation or the like can be supported and damped to achieve the stable high accuracy rotation.

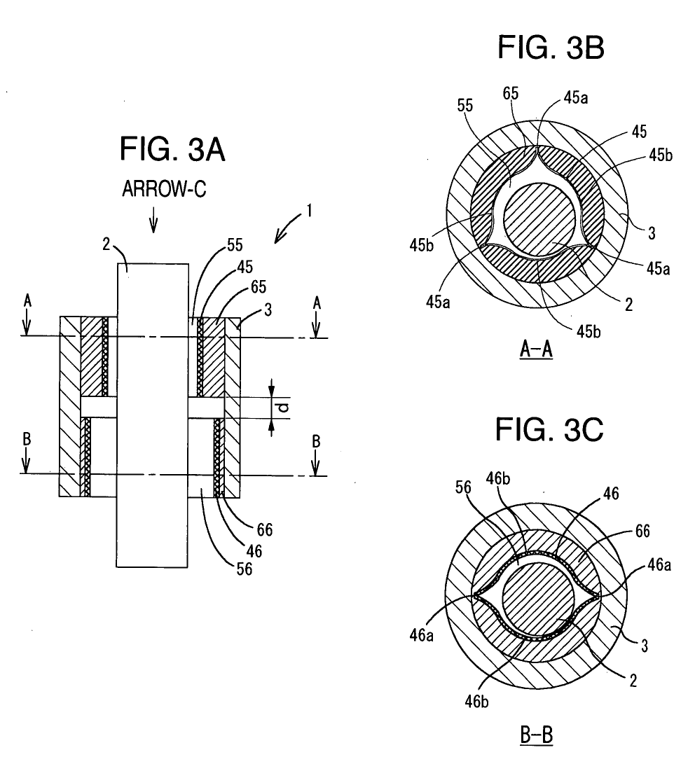

In the first embodiment and its variant example described above, although the journal 2 is supported by two upper and lower foils 41, 42 or by four outer and inner foils 43, 44 each having two vertex parts and two arc surface parts, the journal 2 may be supported by a plurality of foils having a different number of vertex parts. Such an embodiment (a second embodiment) will be described with reference to FIGS. 3A-3C. FIG. 3A is a cross sectional view of a multi-lobe foil gas bearing according to the second embodiment, FIG. 3B is an A-A line cross sectional view of the multi-lobe foil gas bearing shown in FIG. 3A, and FIG. 3C is a B-B line cross sectional view of the multi-lobe foil gas bearing shown in FIG. 3A.

While the number of the vertices of the upper foil 41 and the lower foil 42 placed in the axial direction of the journal is 2 for each foil in the first embodiment, the numbers of vertices vary in the second embodiment, that is, the number of vertices of an upper foil 45 is 3 and the number of vertices of a lower foil 46 is 2, and the vertex parts 45a of the upper foil 45 and the vertex parts 46a of the lower foil 46 are positioned with different phases so that those are not present at the same position in a plan view (seen from an arrow C in the figure). In addition, the multi-lobe foil gas bearing 1 according to the second embodiment has arc surface parts 45b, 46b, viscoelastic materials 65, 66, and clearances 55, 56, respectively corresponding to the foils 45, 46, as with each embodiment described above. Because the numbers of the vertices of the upper foil 45 and the lower foil 46 are different in this way, bearing rigidity and elasticity of the multi-lobe foil gas bearing are varied in an axial direction of the journal to form an optimal fluid lubricating film with respect to rotation characteristics of the journal 2 so that stable high accuracy rotation can be obtained.

Although the embodiments of the present invention have been described above in detail, the design may be changed in various ways without deviating from the sprit of the present invention. For example, the number of the vertices of the foil 41 is not limited to 2 to 3.

In the multi-lobe foil gas bearing according to the present invention, it is required to reduce friction and abrasion between the foils 41 to 46 and the journal 2 at the time of starting or stopping or during low speed rotation. For this purpose, it is desirable to apply chrome plating, hard coating of DLC (diamond-like carbon), or coating of a solid lubricant such as PTFE (polytetrafluoroetylene) or MoS₂ (molybdenum disulfide), which have superior friction characteristics, to at least one of the outer circumferential surface of the journal 2 and the inner circumferential surface of the foils 41 to 46.

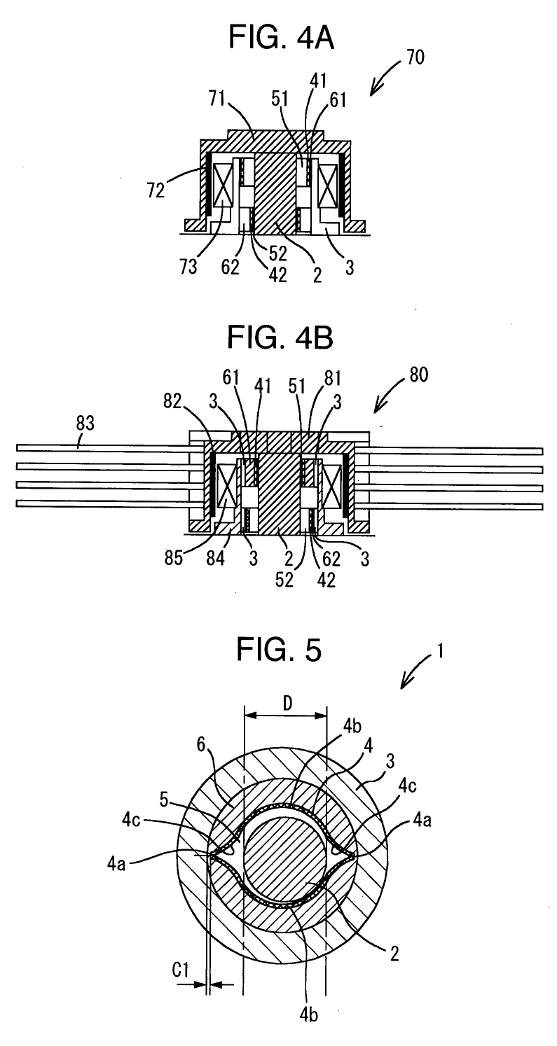

In the multi-lobe foil gas bearing according to the present invention, high accuracy rotation at high rotation speed (10,000 rpm or more) can be accomplished with gas lubrication which requires no gas supplying mechanism, and therefore it is preferable to apply this gas bearing as a bearing of a motor for a hard disk drive, a polygon mirror scanner motor, or a color wheel motor of a rear projection television, as shown in FIGS. 4A and 4B. Specifically, in the case of applying this gas bearing to a rotating spindle 70 of the motor for the hard disk drive as shown in FIG. 4A, a disk fixing member 71 having a cylindrical shape with a bottom surface is fixed to the journal 2 (the disk is omitted in the figure), and a bearing retaining member 3 of a multi-lobe foil gas bearing 1 (having the same structure as the multi-lobe foil gas bearing 1 shown in FIG. 1) for supporting the journal 2 is fixed on a fixing base. On the other hand, a magnet 72 is fixed on the inner circumferential surface of the disk fixing member 71 and a coil 73 is provided around the outer circumferential surface of the bearing retaining member 3. Thus, when the coil 73 is energized, the disk fixing member 71 rotates at high speed with high accuracy by action of current flowing to the magnet 72 and the coil 73. Although the multi-lobe foil gas bearing 1 shown in FIG. 1 is applied, as it is, to the rotating spindle of the motor for the hard disk drive in FIG. 4A, a rotating spindle 80 may be used having the structure in which a disk fixing member 81 (on which a plurality of disks 83 are fixed) having a cylindrical shape with a bottom surface is fixed to the journal 2 and the bearing retaining members 3 of the bearing are separately fixed on an inner circumference of a cylindrical shaft fixing member 84 in upper and lower sides as a multi-lobe foil gas bearing for supporting the journal 2, as shown in FIG. 4B. In this case, the bearing retaining members 3 are formed so as to correspond to the upper and lower foils 41, 42, respectively, and the upper and lower bearing retaining members 3 are fixed on the inner circumference surface of the shaft fixing member 84 fixed on the fixing base, in the upper and lower sides. In addition, a coil 85 is provided around the outer circumferential surface of the shaft fixing member 84 and a magnet is fixed on the inner circumferential surface of the disk fixing member 81. Also in the rotating spindle of the motor for the hard disk drive shown in FIG. 4B, when the coil 85 is energized, the disk fixing member 81 rotates at high speed with high accuracy by action of current flowing the magnet 82 and the coil 85.

Although the case in which the journal 2 rotates while the foils 41 to 46 which are bearing sliding surfaces, the viscoelastic materials 61 to 66, and the bearing retaining member 3 are stationary has been described in the above described embodiments, the multi-lobe foil gas bearing of the present invention can be also adapted to the case in which the journal 2 is stationary while the foils 41 to 46, the viscoelastic materials 61 to 66, and the bearing retaining member 3 rotate.

1. A multi-lobe foil gas bearing comprising:
a bearing retaining member surrounding a periphery of a journal via a clearance;
a foil having a multi-lobe closed-loop shape, the foil being placed within said clearance to constitute a bearing sliding surface opposite to the journal, and comprising one or more vertex parts and arc surface parts of which the number corresponds to the number of vertex parts; and
a viscoelastic material, an elastic material, or a compound material of the viscoelastic material and the elastic material, which is filled into the clearance between said foil and said bearing retaining member opposite to the foil, wherein
the multi-lobe foil gas bearing supports the journal by a fluid lubricating film formed by relative rotation between the journal and the bearing sliding surface, and
a plurality of said closed-loop shape foils are provided along an axial direction of the journal, and are arranged with different phases in a circumferential direction so that each vertex part of at least one of said plurality of foils is located in the arc surface part of the other foil in a plan view seen from a shaft end of the journal.

2. The multi-lobe foil gas bearing according to claim 1, wherein said plurality of foils are arranged so as to be adjacent to each other, or to be spaced with a predetermined distance therebetween, in the axial direction of the journal.

3. The multi-lobe foil gas bearing according to claim 1, wherein the number of the vertices of at least one of said plurality of foils is different from the number of the vertices of the other foil.

4. The multi-lobe foil gas bearing according to claim 2, wherein the number of the vertices of at least one of said plurality of foils is different from the number of the vertices of the other foil.
